(19) United States
(12) Patent Application Publication
(10) Pub. No.: US 2023/0099265 A1
(43) Pub. Date: Mar. 30, 2023

(54) SYSTEMS AND METHODS FOR USE OF AUTONOMOUS ROBOTS FOR PERIMETER PROTECTION

(71) Applicant: Johnson Controls Tyco IP Holdings, LLP, Milwaukee, WI (US)

(72) Inventors: Jason M. OUELLETTE, Sterling, MA (US); Glenn HOLTON, Braintree, MA (US)

(21) Appl. No.: 17/489,456

(22) Filed: Sep. 29, 2021

(51) Int. Cl. B25J 11/00; G05D 1/02; B60Q 9/00

(52) U.S. Cl. CPC B25J 11/002; G05D 1/0212; B60Q 9/00; G05D 2201/0207; G05D 2201/0209

(57) ABSTRACT

Systems and methods for use of autonomous robot for perimeter protection may include a security system configured to receive, from a security device, a security signal, and detect a security event occurred based on the security signal, in response to the security signal being received. The security system may determine a security location for an autonomous mobile machine to perform a security task, in response to the security event being detected, and transmit, to the autonomous mobile machine, first instructions for the autonomous mobile machine to move to the security location to perform the security task.

### TECHNICAL FIELD

The present disclosure relates generally to security systems, and more particularly, to systems and methods for use of autonomous robots for perimeter protection.

### BACKGROUND

Security systems at facilities include devices to detect fires, smoke, gases, water leaks, or other monitored issues for safety. The security systems may rely on notification devices such as strobe lights and noisy alarm systems placed throughout the facility to alert individuals in cases of emergency. However, these types of notifications may not sufficiently communicate to individuals about events happening at the facility, especially those that are entering the facility, or may not help in directing the individuals to safety.

In view of the foregoing, there is a need for improvements in security systems.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In an aspect, a security system including a memory storing instructions and one or more processors coupled with the memory, is provided. The security system may be configured to receive, from a security device of the security system, a security signal. The security system may be configured to identify a security event occurred in a facility based on the security signal, in response to the security signal being received. The security system may be configured to determine a security location in the facility for an autonomous mobile machine to perform a security task, in response to the security event being detected. The security system may be configured to transmit, to the autonomous mobile machine, first instructions for the autonomous mobile machine to move to the security location to perform the security task.

In another aspect, a method for use of an autonomous mobile machine for perimeter protection of a facility by a security system, is provided. The method may include receiving, from a security device of the security system, a security signal. The method may include identifying a security event occurred in the facility based on the security signal, in response to the security signal being received. The method may include determining a security location in the facility for the autonomous mobile machine to perform a security task, in response to the security event being detected. The method may include transmitting, to the autonomous mobile machine, first instructions for the autonomous mobile machine to move to the security location to perform the security task.

In another aspect, a computer-readable medium storing computer executable code for a security system to use of an autonomous mobile machine for perimeter protection of a facility, is provided. The computer-readable medium may include code to receive, from a security device of the security system, a security signal. The computer-readable medium may include code to identify a security event occurred in the facility based on the security signal, in response to the security signal being received. The computer-readable medium may include code to determine a security location in the facility for the autonomous mobile machine to perform a security task, in response to the security event being detected. The computer-readable medium may include code to transmit, to the autonomous mobile machine, first instructions for the autonomous mobile machine to move to the security location to perform the security task.

Further aspects of the present disclosure are described in more details below.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a conceptual diagram of an example security system, according to aspects of the present disclosure;

FIG. 2 is a block diagram of an example map and waypoints used by the security system of FIG. 1, according to aspects of the present disclosure;

FIG. 3 is a flowchart of an example method implemented by the security system of FIG. 1, according to aspects of the present disclosure;

FIG. 4 is a block diagram of the example security control system of FIG. 1 including various hardware components and other features, according to aspects of the present disclosure; and

FIG. 5 is a block diagram of various example system components of the security system of FIG. 1, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Security systems are often used at public and private facilities, such as commercial buildings, businesses, retail establishments, schools, hospitals and government buildings, to list a few examples. Conventionally, security systems rely on notification devices such as strobe lights and noisy alarm systems placed throughout the facilities to alert individuals during a security event (e.g., fire, smoke, or gas detection or active shooter). However, these types of notifications may not sufficiently alert an individual about a security event or a procedure for the individual to follow during the security event.

Aspects of the present disclosure include systems and methods for using autonomous (e.g., fully autonomous or semi-autonomous) mobile machines for perimeter protection. In an example, a security system may detect a security event at a facility based on, for example, a fire/smoke alarm, a gas detection, a security alarm, or any other alarm or detection device coupled with the security system. In response to the security event, the security system may instruct an autonomous mobile machine to a location (e.g., entrance/exit doors) in the facility to perform a security task until the security event is resolved.

Turning now to the figures, example aspects are depicted with reference to one or more components described herein, where components in dashed lines may be optional.

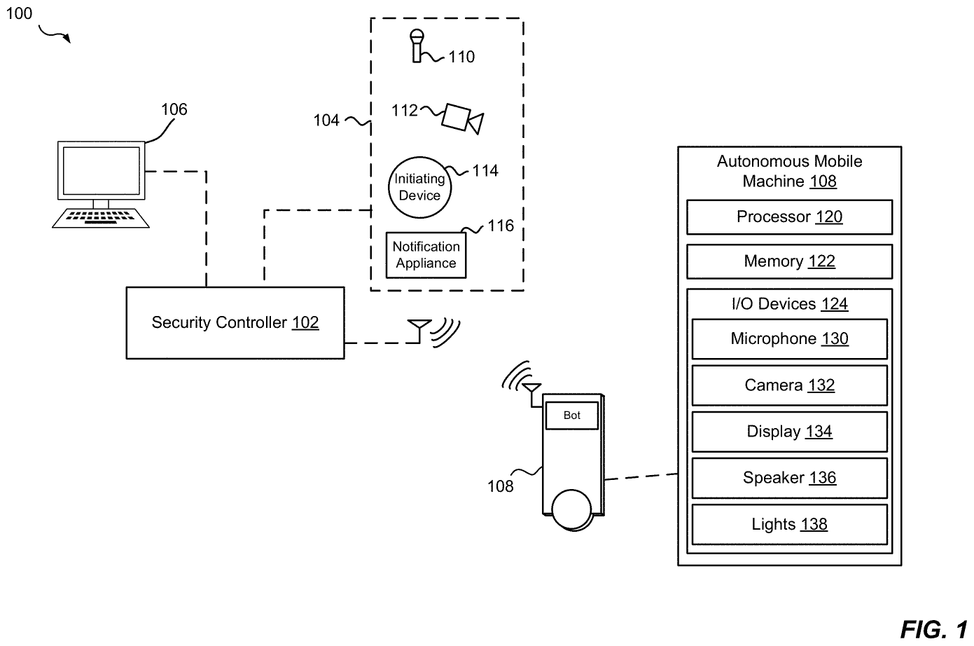

Referring to FIG. 1, an example security system 100 for a facility is depicted. The security system 100 may include a security controller 102 configured to manage security and surveillance functions of the facility. For example, the security controller 102 may communicate with one or more input/output (I/O) devices 104 configured to provide one or more sensor readings or measurements from the facility to the security controller 102 and receive signals for outputting one or more notifications in the facility. Examples of the I/O devices 104 may include, but are not limited to, one or more audio sensors 110 (e.g., microphone), imaging devices 112 (e.g., image or video camera), initiating devices 114 (e.g., fire sensor, smoke sensor, gas sensor, temperature sensor, humidity sensor, or a pull switch), or notification appliances 116 (e.g., alarm or strobe lights).

The security controller 102 may also communicate with one or more monitoring stations 106. In an example, the security controller 102 may transmit information corresponding to input devices of the I/O devices 104 (e.g., audio/video sample from audio sensor 110/imaging device 112 or signals from initiating devices 114) to a monitoring station 106 and may receive instructions from the monitoring station 106.

In an aspect, communication between the security controller 102 and the I/O devices 104 or the security controller 102 and the monitoring station 106 may be through a wired (e.g., fiber optics or cable) link and/or wireless link (e.g., Wi-Fi or cellular).

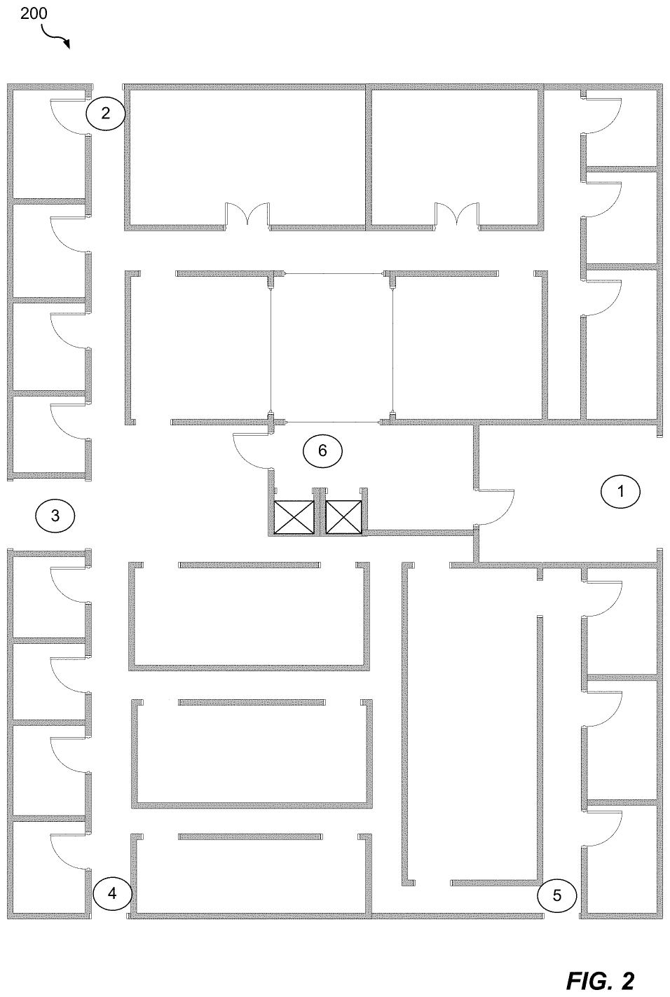

The security controller 102 may also communicate with one or more autonomous mobile machines 108 (e.g., robot or drone) capable of moving about the facility to provide security and surveillance functions at different areas and/or stopping points of the facility. In an aspect, the autonomous mobile machine 108 may include one or more processors 120 for controlling the autonomous mobile machine 108 based on instructions received from the security controller 102 or stored in a memory 122 of the autonomous mobile machine 108. In an example, the memory 122 may store data corresponding to a map (see e.g., map 200 of FIG. 2) of the facility and designated stopping points (e.g., stopping points 1-8 of FIG. 2) throughout the facility.

In an example, the autonomous mobile machine 108 also includes one or more I/O devices 124. Examples of the input devices may include one or more devices, such as, but not limited to, an audio sensor (e.g., microphone 130), an imaging device (e.g., image/video camera 132), for capturing input at designated area of the facility. The input devices may include one or more devices, such as, but not limited to, a display 134, an alarming device (e.g., speaker 136), or lights 138, for providing information corresponding to a security event.

Referring to FIG. 2, an example map 200 of a facility may include a plurality of stopping points (e.g., stopping points 1-8) corresponding to, for example, entrance/exit locations of the facility. Conventionally, a security system uses flashing lights, loud noises, and occasional exit signs during a security event to inform individuals on procedures to perform during the security event, which may cause confusion as these types of alerts are extremely limiting in providing information to the individuals.

Aspects of the current disclosure may overcome the shortcomings of conventional security systems by implementing one or more autonomous mobile machines to provide support during security events. As described in greater detail below, the security controller 102 may determine a security event has occurred based on, for example, a signal from one or more initiating devices 114, and instruct the autonomous mobile machine 108 to move to a stopping point (e.g., stopping point 1-8) in the facility and provide a safety procedure for individuals to follow.

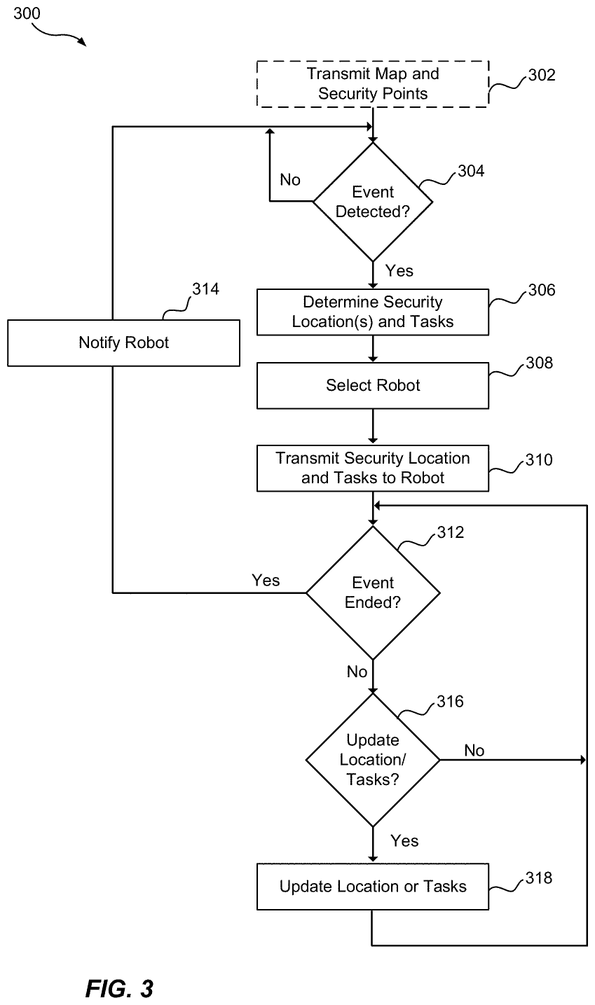

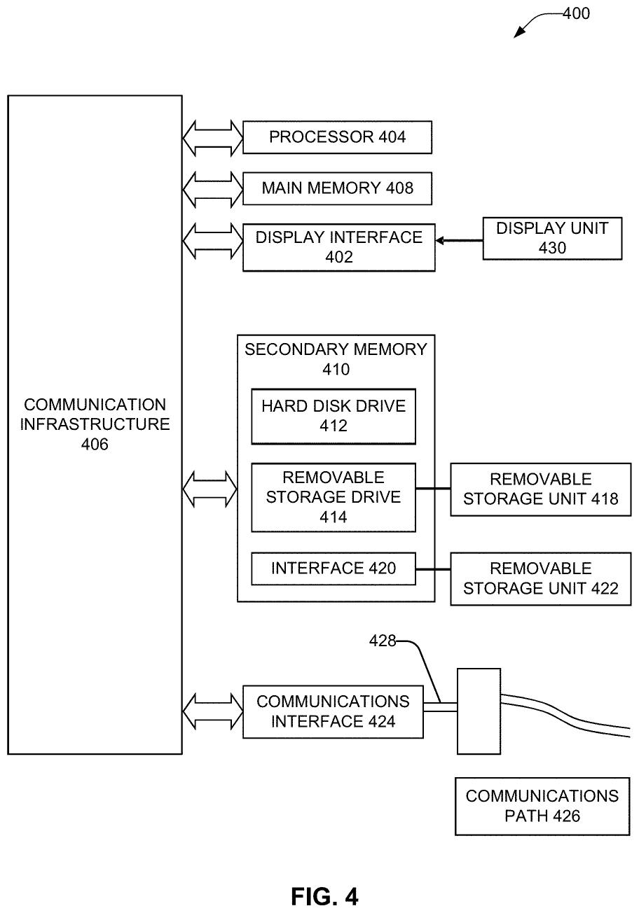

Referring to FIG. 3, an example method 300 of controlling the security system 100 is depicted. The operations of the method 300 may be performed by one or more components (e.g., security controller 102 of FIG. 1, and/or processor 404, memory 408, memory 410, or communications interface 424 of FIG. 4) of the security system 100, as described herein.

At block 302, the security controller 102 may optionally provide one or more of the data for the map 200 to the autonomous mobile machine 108 and/or the data for the plurality of stopping points 1-6 in the map 200. The data may allow the autonomous mobile machine 108 to know a layout of a facility (e.g., floor or designated area) and determine paths to arrive at the stopping points 1-6. In another example, the data corresponding to the map 200 and/or the stopping points 1-6 may be received by the autonomous mobile machine 108 through other means such as a manual upload (e.g., manual connection to a detachable memory device) or an upload through the Internet/intranet.

At block 304, the security controller 102 may monitor for any security events. The security event may include, for example, detection of a fire, smoke, or gas, indication of an unauthorized individual in the facility (e.g., intruder or active shooter), or any other security, safety, or emergency that may be detected or cause one or more of the initiating devices 114 or the monitoring station 106 to send a signal to the security controller 102.

If a security event occurs, the security controller 102 may determine a location to send the autonomous mobile machine 108 to perform a security task, at block 306. In an example, the security controller 102 may store (e.g., in memory) a list of the stopping points 1-6 of the map 200 of FIG. 2 and corresponding security events associated with each of the stopping points 1-6. The security controller 102 may determine a location for sending an autonomous mobile machine based on which stopping points are associated to a present security event. For example, if the security event corresponds to a fire detection or smoke detection, the location may be near the elevators at the stopping point 6 of FIG. 2 to inform individuals not to enter the elevators, or in the case of an unauthorized individual in the facility, the location may be an entrance/exit of the facility (or floor) such as stopping point 1 of FIG. 2 to inform individuals to exit or not to enter the facility.

In an aspect, the security controller 102 may optionally determine one or more security tasks to be performed at the security location. The security tasks may include, for example, communicating via the display 134, the speaker 136, and/or the lights 138 indications of the security event and/or instructions for individuals to follow due to the security event. For example, if the event corresponds to a fire or gas leak, the security task may include directing people to an exit not impacted by the fire or the gas leak. In an example, the security controller 102 may store default security tasks to be performed based on a security event. In another example, the security controller 102 may determine the security tasks, after the autonomous mobile machine 108 is selected at block 308, based on capabilities (e.g., available I/O devices 124 of the autonomous mobile machine 108) of the autonomous mobile machine 108.

At block 308, the security controller 102 may select the autonomous mobile machine 108 from a plurality of autonomous mobile machines, if available. Selection of the autonomous mobile machine 108 may be based on, for example, an availability of the autonomous mobile machine 108, a proximity of the autonomous mobile machine 108 to the determined security location, or the capabilities of the autonomous mobile machine 108. In an example, before selecting the autonomous mobile machine 108, the security controller 102 may transmit one or more requests, such as an availability request, a location request, and/or a capabilities request, to one or more autonomous mobile machines 108 to determine the availability, location, or capabilities of the autonomous mobile machines 108. Based on a response (or responses) to a request, the security controller 102 may select the autonomous mobile machine 108. In another example, multiple autonomous mobile machines 108 may be selected to perform security tasks.

At block 310, the security controller 102 may transmit the security location and/or the security tasks to the selected autonomous mobile machine 108. In an example, the security controller 102 may receive a confirmation signal indicating that the autonomous mobile machine 108 received the security location and/or the security tasks.

At block 312, the security controller 102 may monitor whether the security event has ended. For example, the security controller 102 may receive a signal from an initiating device 114 or the monitoring station 106 indicating that the security event has ended. If the security event has ended, the security controller 102, at block 314, may notify the autonomous mobile machine 108, which in return may provide updated information (e.g., display of “No fire, please return to office,” or lighting turning to green) to individuals based on the end of the security event, and/or instruct the autonomous mobile machine 108 to return to a charging station.

If the security event has not ended, the security controller 102 may determine whether the update a security location and/or a security task of the autonomous mobile machine 108, at block 316. For example, the security controller 102 may receive information from the monitoring station 106 indicating a different location and/or task for the autonomous mobile machine 108 to go and/or perform. The security controller 102 may update the location or task by transmitting the information to the autonomous mobile machine 108, at block 318. If no update is needed, at block 316, the security controller 102 verifies whether the security event has ended, at block 312.

Referring to FIG. 4, an example system 400 is presented with a diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system 400 is shown in FIG. 4. In an aspect, the security controller 102 of FIG. 1 may be implemented using the computer system 400.

The computer system 400 may include one or more processors, such as processor 404. The processor 404 may be connected to a communication infrastructure 406 (e.g., a communications bus, cross-over bar, or network). Various software aspects are described in terms of this example computer system 400. After reading this description, it will become apparent to an individual skilled in the relevant art(s) how to implement aspects described herein using other computer systems and/or architectures.

The computer system 400 may include a display interface 402 that forwards graphics, text, and other data from the communication infrastructure 406 (or from a frame buffer not shown) for display on a display unit 430. The computer system 400 may also include a main memory 408, e.g., random access memory (RAM), and may also include a secondary memory 410. The secondary memory 410 may include, e.g., a hard disk drive 412 and/or a removable storage drive 414, representing a floppy disk drive, a magnetic tape drive, an optical disk drive, etc. The removable storage drive 414 may read from and/or write to a removable storage unit 418 in a well-known manner. The removable storage unit 418, represents a floppy disk, magnetic tape, optical disk, etc., which is read by and written to the removable storage drive 414. As will be appreciated, the removable storage unit 418 may include a computer usable storage medium having stored therein computer software and/or data.

In alternative aspects, the secondary memory 410 may include other similar devices for allowing computer programs or other instructions to be loaded into the computer system 400. Such devices may include, e.g., a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to the computer system 400.

The computer system 400 may also include a communications interface 424. The communications interface 424 may allow software and data to be transferred between the computer system 400 and external devices. Examples of the communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical, wireless, or other signals capable of being received by the communications interface 424. These signals 428 are provided to the communications interface 424 via a communications path (e.g., channel) 426. The communications path 426 may carry signals 428 and may be implemented using wire or cable, fiber optics, a telephone line, a cellular link, a radio frequency (RF) link and/or other communications channels. The terms “computer program medium,” “computer usable medium,” “computer readable medium,” or “non-transitory computer readable medium” may be used to refer generally to media such as a removable storage drive, a hard disk installed in a hard disk drive, and/or signals 428. These computer program products provide software to the computer system 400. Aspects described herein may be directed to such computer program products.

Computer programs (also referred to as computer control logic or applications may be stored in the main memory 408 and/or the secondary memory 410. The computer programs may also be received via the communications interface 424. Such computer programs, when executed, enable the computer system 400 to perform various features in accordance with aspects described herein. In particular, the computer programs, when executed, enable the processor 404 to perform such features. Accordingly, such computer programs represent controllers of the computer system 400. The computer programs may include instructions or code for executing methods described herein.

In variations where aspects described herein are implemented using software, the software may be stored in a computer program product and loaded into the computer system 400 using the removable storage drive 414, the hard disk drive 412, or the interface 420. The control logic (software), when executed by the processor 404, causes the processor 404 to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to individuals skilled in the relevant art(s).

In yet another example variation, aspects described herein are implemented using a combination of both hardware and software.

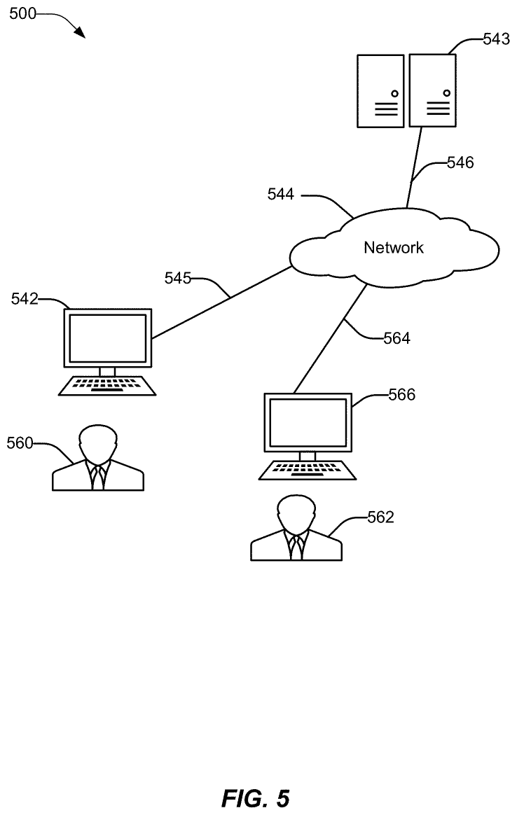

FIG. 5 is a block diagram of various example system components. FIG. 5 shows a communication system 500 including one or more users 560, 562 and one or more terminals 542, 566. The terminals 542, 566 may include the security controller 102 or the monitoring station 106 of FIG. 1 or the computer system 400 of FIG. 4 or a related system or subsystem, and/or the like. In one aspect, data for use in accordance with aspects described herein may be input and/or accessed by the users 560, 562 via the terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, a network 544 for instance, such as the Internet or an intranet, and couplings 545, 546, 564. The couplings 545, 546, 564 may include wired, wireless, or fiber optic links. In another example variation, the method and system in accordance with aspects described herein operate in a stand-alone environment, such as on a single terminal.

### Additional Embodiments

An example security system, comprising: a memory storing instructions; and one or more processors coupled with the memory and configured to execute the instructions to: receive, from a security device of the security system, a security signal; identify a security event occurred in a facility based on the security signal, in response to the security signal being received; determine a security location in the facility for an autonomous mobile machine to perform a security task, in response to the security event being detected; and transmit, to the autonomous mobile machine, first instructions for the autonomous mobile machine to move to the security location to perform the security task.

The above-example security system, wherein the one or more processors is further configured to: determine the security task corresponding to the security event, in response to the security event being detected; and transmit, to the autonomous mobile machine, second instructions for the autonomous mobile machine to perform the security task at the security location.

One or more of the above-example security systems, wherein the one or more processors is further configured to: select the autonomous mobile machine from a plurality of autonomous mobile machines based on the security event.

One or more of the above-example security systems, wherein the autonomous mobile machine is further selected based on one or more capabilities of the autonomous mobile machine or a current location of the autonomous mobile machine.

One or more of the above-example security systems, wherein the one or more processors is further configured to: transmit, to the autonomous mobile machine, an availability request signal requesting availability of the autonomous mobile machine, wherein the first instructions are transmitted to the autonomous mobile machine based on an availability confirmation signal being received from the autonomous mobile machine in response to the availability request signal.

One or more of the above-example security systems, wherein the security task includes one or more of displaying a message on a display of the autonomous mobile machine, enabling or disabling a light of the autonomous mobile machine, or generating a sound from an output device on the autonomous mobile machine.

One or more of the above-example security systems, wherein the one or more processors is further configured to: receive, from the autonomous mobile machine, a confirmation signal indicating the autonomous mobile machine has arrived at the security location or is performing the security task at the security location.

An example method for use of an autonomous mobile machine for perimeter protection of a facility by a security system, comprising: receiving, from a security device of the security system, a security signal; identifying a security event occurred in the facility based on the security signal, in response to the security signal being received; determining a security location in the facility for the autonomous mobile machine to perform a security task, in response to the security event being detected; and transmitting, to the autonomous mobile machine, first instructions for the autonomous mobile machine to move to the security location to perform the security task.

The above-example method, further comprising: determining the security task corresponding to the security event, in response to the security event being detected; and transmitting, to the autonomous mobile machine, second instructions for the autonomous mobile machine to perform the security task at the security location.

One or more of the above-example methods, further comprising: selecting the autonomous mobile machine from a plurality of autonomous mobile machines based on the security event.

One or more of the above-example methods, wherein the autonomous mobile machine is further selected based on one or more capabilities of the autonomous mobile machine or a current location of the autonomous mobile machine.

One or more of the above-example methods, further comprising: transmitting, to the autonomous mobile machine, an availability request signal requesting availability of the autonomous mobile machine, wherein the first instructions are transmitted to the autonomous mobile machine based on an availability confirmation signal being received from the autonomous mobile machine in response to the availability request signal.

One or more of the above-example methods, wherein the security task includes one or more of displaying a message on a display of the autonomous mobile machine, enabling or disabling a light of the autonomous mobile machine, or generating a sound from an output device on the autonomous mobile machine.

One or more of the above-example methods, further comprising: receiving, from the autonomous mobile machine, a confirmation signal indicating the autonomous mobile machine has arrived at the security location or is performing the security task at the security location.

An example computer-readable medium storing computer executable code for a security system to use of an autonomous mobile machine for perimeter protection of a facility, the computer-readable medium comprising code to: receive, from a security device of the security system, a security signal; identify a security event occurred in the facility based on the security signal, in response to the security signal being received; determine a security location in the facility for the autonomous mobile machine to perform a security task, in response to the security event being detected; and transmit, to the autonomous mobile machine, first instructions for the autonomous mobile machine to move to the security location to perform the security task.

The above-example computer-readable medium, further comprising code to: determine the security task corresponding to the security event, in response to the security event being detected; and transmit, to the autonomous mobile machine, second instructions for the autonomous mobile machine to perform the security task at the security location.

One or more of the above-example computer-readable mediums, further comprising code to: select the autonomous mobile machine from a plurality of autonomous mobile machines based on the security event.

One or more of the above-example computer-readable mediums, wherein the autonomous mobile machine is further selected based on one or more capabilities of the autonomous mobile machine or a current location of the autonomous mobile machine.

One or more of the above-example computer-readable mediums, further comprising code to: transmit, to the autonomous mobile machine, an availability request signal requesting availability of the autonomous mobile machine, wherein the first instructions are transmitted to the autonomous mobile machine based on an availability confirmation signal being received from the autonomous mobile machine in response to the availability request signal.

One or more of the above-example computer-readable mediums, wherein the security task includes one or more of displaying a message on a display of the autonomous mobile machine, enabling or disabling a light of the autonomous mobile machine, or generating a sound from an output device on the autonomous mobile machine.

The previous description is provided to enable any individual skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A security system, comprising:
a memory storing instructions; and
one or more processors coupled with the memory and configured to execute the instructions to:
receive, from a security device of the security system, a security signal;
identify a security event occurred in a facility based on the security signal, in response to the security signal being received;
determine a security location in the facility for an autonomous mobile machine to perform a security task, in response to the security event being detected; and
transmit, to the autonomous mobile machine, first instructions for the autonomous mobile machine to move to the security location to perform the security task.

2. The security system of claim 1, wherein the one or more processors is further configured to:
determine the security task corresponding to the security event, in response to the security event being detected; and
transmit, to the autonomous mobile machine, second instructions for the autonomous mobile machine to perform the security task at the security location.

3. The security system of claim 1, wherein the one or more processors is further configured to:
select the autonomous mobile machine from a plurality of autonomous mobile machines based on the security event.

4. The security system of claim 3, wherein the autonomous mobile machine is further selected based on one or more capabilities of the autonomous mobile machine or a current location of the autonomous mobile machine.

5. The security system of claim 3, wherein the one or more processors is further configured to:
transmit, to the autonomous mobile machine, an availability request signal requesting availability of the autonomous mobile machine,
wherein the first instructions are transmitted to the autonomous mobile machine based on an availability confirmation signal being received from the autonomous mobile machine in response to the availability request signal.

6. The security system of claim 1, wherein the security task includes one or more of displaying a message on a display of the autonomous mobile machine, enabling or disabling a light of the autonomous mobile machine, or generating a sound from an output device on the autonomous mobile machine.

7. The security system of claim 1, wherein the one or more processors is further configured to:
receive, from the autonomous mobile machine, a confirmation signal indicating the autonomous mobile machine has arrived at the security location or is performing the security task at the security location.

8. A method for use of an autonomous mobile machine for perimeter protection of a facility by a security system, comprising:
receiving, from a security device of the security system, a security signal;
identifying a security event occurred in the facility based on the security signal, in response to the security signal being received;
determining a security location in the facility for the autonomous mobile machine to perform a security task, in response to the security event being detected; and
transmitting, to the autonomous mobile machine, first instructions for the autonomous mobile machine to move to the security location to perform the security task.

9. The method of claim 8, further comprising:
determining the security task corresponding to the security event, in response to the security event being detected; and
transmitting, to the autonomous mobile machine, second instructions for the autonomous mobile machine to perform the security task at the security location.

10. The method of claim 8, further comprising:
selecting the autonomous mobile machine from a plurality of autonomous mobile machines based on the security event.

11. The method of claim 10, wherein the autonomous mobile machine is further selected based on one or more capabilities of the autonomous mobile machine or a current location of the autonomous mobile machine.

12. The method of claim 10, further comprising:
transmitting, to the autonomous mobile machine, an availability request signal requesting availability of the autonomous mobile machine,
wherein the first instructions are transmitted to the autonomous mobile machine based on an availability confirmation signal being received from the autonomous mobile machine in response to the availability request signal.

13. The method of claim 8, wherein the security task includes one or more of displaying a message on a display of the autonomous mobile machine, enabling or disabling a light of the autonomous mobile machine, or generating a sound from an output device on the autonomous mobile machine.

14. The method of claim 8, further comprising:
receiving, from the autonomous mobile machine, a confirmation signal indicating the autonomous mobile machine has arrived at the security location or is performing the security task at the security location.

15. A computer-readable medium storing computer executable code for a security system to use of an autonomous mobile machine for perimeter protection of a facility, the computer-readable medium comprising code to:
receive, from a security device of the security system, a security signal;
identify a security event occurred in the facility based on the security signal, in response to the security signal being received;
determine a security location in the facility for the autonomous mobile machine to perform a security task, in response to the security event being detected; and
transmit, to the autonomous mobile machine, first instructions for the autonomous mobile machine to move to the security location to perform the security task.

16. The computer-readable medium of claim 15, further comprising code to:
determine the security task corresponding to the security event, in response to the security event being detected; and
transmit, to the autonomous mobile machine, second instructions for the autonomous mobile machine to perform the security task at the security location.

17. The computer-readable medium of claim 15, further comprising code to:
select the autonomous mobile machine from a plurality of autonomous mobile machines based on the security event.

18. The computer-readable medium of claim 17, wherein the autonomous mobile machine is further selected based on one or more capabilities of the autonomous mobile machine or a current location of the autonomous mobile machine.

19. The computer-readable medium of claim 17, further comprising code to:
transmit, to the autonomous mobile machine, an availability request signal requesting availability of the autonomous mobile machine,
wherein the first instructions are transmitted to the autonomous mobile machine based on an availability confirmation signal being received from the autonomous mobile machine in response to the availability request signal.

20. The computer-readable medium of claim 15, wherein the security task includes one or more of displaying a message on a display of the autonomous mobile machine, enabling or disabling a light of the autonomous mobile machine, or generating a sound from an output device on the autonomous mobile machine.
